(19) United States
(12) Patent Application Publication
(10) Pub. No.: US 2011/0152165 A1
(43) Pub. Date: Jun. 23, 2011

(54) Cleaning Composition Containing Hemicellulose

(76) Inventors: Nigel Patrick Somerville Roberts, Newcastle upon Tyne (GB); Paul Ronald Hudson, Middlesborough (GB); Neil Joseph Lant, Newcastle upon Tyne (GB); Alan Thomas Brooker, Newcastle upon Tyne (GB)

(21) Appl. No.: 12/968,605

(22) Filed: Dec. 15, 2010

(30) Foreign Application Priority Data
Dec. 18, 2009 (EP) 09180031.8

(51) Int. Cl. C11D 3/22

(52) U.S. Cl. 510/473

(57) ABSTRACT

A cleaning composition having polysaccharides, the polysaccharides having from about 5 to about 95% by weight of water-soluble, unsubstituted hemicellulose.

### FIELD OF THE INVENTION

The present invention relates to a cleaning composition comprising hemicellulose. More particularly, the hemicellulose in the present invention provide suds boosting benefit, such as suds volume and suds duration enhancement, to cleaning compositions such as fabric care products, dish care products, or applications where cleaning of surfaces is needed.

### BACKGROUND OF THE INVENTION

Cleaning compositions must satisfy several criteria in order to be effective and fulfill the need of the consumer. In particular, the presence of suds in a cleaning operation has long been used as a signal that the detergent continues to be effective. However, depending upon the circumstances, the presence of suds or the lack thereof, may have little or no bearing upon the efficacy of the cleaning process. Therefore, the consumer who relies upon a somewhat erroneous signal may tend to use an excess of cleaning product in the lack or absence of suds.

Accordingly, there remains a need for adjusting the sudsing properties of a cleaning composition with flexibility, in particular to adjust the sudsing properties relatively independently from the cleaning properties. This is especially needed for cleaning composition comprising a low level of surfactant or of builder.

The inventors have discovered that some or all of the above mentioned needs could be at least partially fulfilled in the cleaning composition comprising polysaccharides, the polysaccharides comprising from 5% to 95% by weight of unsubstituted hemicellulose. Unless otherwise specified, all percentage and ratio are in weight.

### SUMMARY OF THE INVENTION

The present invention relates to a cleaning composition comprising polysaccharides, the polysaccharides comprising from 5% to 95% by weight of unsubstituted hemicellulose. Preferably, the cleaning composition comprises polysaccharides, the polysaccharides comprising from 5% to 95% by weight of water-soluble, unsubstituted hemicellulose

The cleaning composition of the invention may have a solid form. The cleaning composition may be a free flowing powder. The free flowing powder may comprise non-hydrophobic solid material.

Cleaning composition having a solid form, may have a density which is not optimized. It has been found that this could be at least partially alleviated by the presence of the specific polysaccharides of the invention. The adjustment of the density of a solid cleaning composition is particularly relevant when the composition is in free flowing form, in particular when the powder comprises non hydrophobic solid material.

The cleaning composition of the invention may be liquid or may be prepared by processing a liquid. The viscosity of the liquid composition is not always optimal. It has been found that this could be at least partially alleviated by the presence of the polysaccharides of the invention.

### DETAILED DESCRIPTION OF THE INVENTION

### Polysaccharides

The cleaning composition of the invention comprises polysaccharides.

The composition of the invention may comprise at least 1%, or 2%, preferably at least 5% or 10%, typically at least 15% or 20% by weight of polysaccharides. The cleaning composition may comprise at least 30% or at least 40% or 50% of polysaccharides.

The cleaning composition may comprise at most 95%, or at most 90%, or 80%, or 60%, by weight of polysaccharides.

The polysaccharides comprise from 5% to 95% by weight of unsubstituted hemicellulose. The polysaccharides preferably comprise at least 7%, in particular at least 10%, 20%, 30%, or 40%, or even 50% by weight of unsubstituted hemicellulose. The polysaccharides may comprise at least 60%, 70% or at least 80% or 90% by weight of unsubstituted hemicellulose.

The polysaccharides preferably comprise at least 5%, in particular at least 10%, 20%, 30%, or 40%, or even 50% by weight of water-soluble, unsubstituted hemicellulose. The polysaccharides may comprise at least 60%, 70% or at least 80% or 90% by weight of water-soluble, unsubstituted hemicellulose.

The polysaccharides preferably comprise at most 90%, in particular at most 80%, typically at most 60% by weight of unsubstitued hemicellulose.

The polysaccharides preferably comprise at most 90%, in particular at most 80%, typically at most 60% by weight of water-soluble, unsubstitued hemicellulose.

In addition to the unsubstituted hemicellulose, the polysaccharides comprise one or more other polysaccharide. The polysaccharides may comprise, substituted hemicellulose, cellulose, starch, pectin, glycogen, fructan, exudate gum, seaweed polysaccharides, dextran, mutan, alternan, pullanan, xanthan, or mixture thereof. The one or more other polysaccharides may be substituted.

According to a preferred embodiment of the invention, the polysaccharide comprises cellulose. The cellulose may comprise unsubstituted and/or substituted cellulose.

The weight ratio cellulose/(unsubstituted hemicellulose) may be comprised between 0.02 and 20, in particular between 0.05 and 2, or between 0.1 and 1, or 0.15 and 0.80, or even between 0.30 and 0.60. The weight ratio cellulose/(water-soluble, unsubstituted hemicellulose) may be comprised between 0.02 and 20, in particular between 0.05 and 2, or between 0.1 and 1, or 0.15 and 0.80, or even between 0.30 and 0.60. The weight ratio (unsubstituted cellulose)/(unsubstituted hemicellulose) may be comprised between 0.02 and 20, in particular between 0.05 and 2, or between 0.1 and 1, or 0.15 and 0.80, or even between 0.30 and 0.60. The weight ratio (unsubstituted cellulose)/(water-soluble, unsubstituted hemicellulose) may be comprised between 0.02 and 20, in particular between 0.05 and 2, or between 0.1 and 1, or 0.15 and 0.80, or even between 0.30 and 0.60.

The cleaning composition may comprise lignin. The weight ratio lignin/(unsubstituted hemicellulose) may be comprised between 0.02 and 20, in particular between 0.05 and 2, or between 0.1 and 1, or 0.15 and 0.50, or even between 0.20 and 0.30. The weight ratio lignin/(water-soluble, unsubstituted hemicellulose) may be comprised between 0.02 and 20, in particular between 0.05 and 2, or between 0.1 and 1, or 0.15 and 0.50, or even between 0.20 and 0.30.

### Hemicellulose

The cleaning composition of the invention comprises unsubstituted hemicellulose, preferably water-soluble, unsubstituted hemicellulose.

Preferably, at least part of the unsubstituted hemicellulose is water soluble. By water soluble, it is meant that the unsubstituted hemicellulose is soluble in deionised water at 25° C. The proportion of water soluble, unsubsistuted hemicellulose of a hemicellulose containing material is measured as such: 20 g of the hemicellulose containing material is introduced in 1 liter of 25° C. 1 molar NaOH solution in a standard 1 litre SOTAX stirrer. It is mixed at 200 rpm at 25° C. for 10 minutes. A sample of the solution is then removed and filtered—typically using a 50 ml syringe fitted with a 25 mm Whatman GD/X filter to remove all undissolved or insoluble material. The quantity of hemicellulose present in the solution is determined by mass spectroscopy using this filtered sample.

The composition of the invention may comprise at least 1%, or 2%, preferably at least 5% or 10%, typically at least 15% or 20% by weight of unsubstituted hemicellulose. The cleaning composition may comprise at least 30% or at least 40% or 50% of unsubstituted hemicellulose. The composition of the invention may comprise at least 1%, or 2%, preferably at least 5% or 10%, typically at least 15% or 20% by weight of water-soluble, unsubstituted hemicellulose. The cleaning composition may comprise at least 30% or at least 40% or 50% of water-soluble, unsubstituted hemicellulose.

The cleaning composition may comprise at most 95%, or at most 90%, or 80%, or 60%, by weight of unsubstituted hemicellulose. The cleaning composition may comprise at most 95%, or at most 90%, or 80%, or 60%, by weight of water-soluble, unsubstituted hemicellulose.

Hemicellulose is a polysaccharide comprising a plurality of sugar units. The hemicellulose comprises a backbone and optionally, carbohydrate side chains.

The hemicellulose backbone preferably comprises sugar units selected from xylose, mannose, glucose, galactose, and mixture thereof.

Preferably, the hemicellulose backbone comprises at least 50%, or 75%, for example at least 85% or 90% or 95% by weight of sugar unit selected from xylose, mannose, and mixtures thereof. According to an embodiment of the invention, the hemicellulose backbone comprises at least 50%, or 75%, for example at least 85% or 90% or 95% by weight of xylose. According to an embodiment of the invention, the hemicellulose backbone comprises at least 50%, or 75%, for example at least 85% or 90% or 95% by weight of mannose.

The hemicellulose may comprise carbohydrate side chain comprising carbohydrate selected from D-glururonic acid or its 4-O-methyl ether, L-arabinose, D-xylose, D- or L-galactose, D-glucose, and mixture therof.

The hemicellulose may comprise xylan, mannan, β-glucans with mixed linkages, xyloglucans, and mixtures thereof. Ebringerová, Hromádková, and Heinze have described hemicellulose in an article published online on 31 Aug. 2005: “hemicellulose” in Adv Polym Sci (2005) 186: 1-67.

The hemicellulose may comprise homoxylan and/or heteroxylan which includes glucuronoxylans, (arabino)glucuronoxylans, (glucurono)arabinoxylans, arabinoxylans, complex heteroxylans, and mixtures thereof.

The xylan may be a homopolymer with a backbone comprising xylopyranose residues linked by β-(1→3) or mixed β-(1→3, 1→4) glycosidic linkages.

Preferably, the xylan comprises a heteropolymer having a backbone comprising β-(1→4)-D-xylopyranose. The backbone being preferably branched by carbohydrate chains. The carbohydrate chain may comprise D-glururonic acid or its 4-O-methyl ether, L-arabinose, oligosaccharides, and mixture thereof. The oligosaccharide may comprise D-xylose, L-arabinose, D- or L-galactose, D-glucose, and mixture therof.

The hemicellulose may comprise gluronoxylans. The glucuronoxylans may comprise glucuronic acid side chain in the 4-O-methylated and non-methylated forms. The molar ratio of xylose to 4-O-methyl-α-D-glucopyranosyl uronic acid residue may be comprised between 4:1 and 16:1.

The hemicellulose may comprise D-mannoglycans. The hemicellulose may comprise galactomannans and/or glucomannans. The galactomannans may have a backbone essentially consisting of β-(1→4)-D-mannopyranose. The glucomannans may have a backbone consisting essentialy of both β-(1→4)-D-mannopyranose and β-(1→4)-D- glucopyranose

The glucomannan may comprise galactoglucomannan.

The hemicellulose may comprise D-Xylo-D-glucans, mixed linkage (1→3, 1→4) β-D-glucans, and/or L-arabino-D-galactans.

Preferably, the hemicellulose comprises from 0% or from 1% to 50% by weight of anhydrous glucose monomers. The hemicellulose may comprise less than 40%, in particular less than 30% or less than 20% or less than 10% of anhydrous glucose monomers.

The hemicellulose may have an average per weight molecular weight of between 500 and 500.000 g/mol, for example between 1.000 and 400.000 or between 2.000 and 100.000 or between 3.000 and 50.000 g/mol.

The hemicellulose preferably comprises an average by weight of sugar comprised between 10 and 10.000 sugar units, in particular between 40 and 6,000 or between 100 and 3000 or between 500 and 1000 sugar units.

The hemicellulose may be extracted from plant material such as leaves, trees, straws, agricultural product, weeds and mixtures thereof. According to a preferred embodiment, the hemicellulose is extracted from leaves. Leaves comprise hemicellulose and cellulose in one of the preferred ratio of the invention.

According to one embodiment of the invention, the hemicellulose is hemicellulose extracted from leaves. In particular, the hemicellulose may be extracted from leaves having a pleasant colour, for example a red, blue, purple or pink colour. The hemicellulose may be extracted from leaves of plants having a pleasant smell. The hemicellulose may be extracted from lavander or eucalyptus leaves.

It may be preferred that at least part of the hemicellulose is extracted from plants which are associated with a pleasant fragrance or colour by the consumer.

The hemicellulose of the invention may be obtained by any suitable process disclosed in the art.

The hemicellulose may be obtained by a process involving one or more of the following steps.

A plant material comprising hemicellulose may be milled, preferably to a size of less than 100 μm or less than 75 μm or less than 50 μm or less than 25 μm. The size may be measured by laser diffraction techniques—e.g. using equipment supplied by Sympatec®.

The plant material, preferably milled, is preferably mixed with a solution that will hydrolyze the hemicellulose. The plant material, preferably milled, may be mixed with an alkaline solution of pH above 8 or above 9 or above 10. Alternatively the milled plant material could be mixed with a low pH solution such as pH 3 or lower to cause acid hydrolysis of the hemicellulose.

Milling and mixing the plant material in an alkaline or acidic solution increases the water solubility of the hemicellulose.

The solution comprising the hemicellulose may be bleached and/or dried. The resulting hemicellulose containing material may have a density of less than 500 g/l or less than 400 g/l or less than 300 g/l.

The solution may also be admixed directly with additional ingredients of the cleaning composition before being dried.

The drying step may be obtained by spreading materials out to let them dry in the sun and then optionally further grounding, or by spray drying.

### Adjunct Ingredient

The cleaning composition may comprise one or more adjunct ingredient(s). The precise nature of these additional adjunct components, and levels of incorporation thereof, will depend on the physical form of the composition and the nature of the operation for which it is to be used.

For example when the cleaning composition is a fabric care composition, suitable adjunct materials include, but are not limited to surfactant, builder, flocculating aid, chelating agents, dye transfer inhibitors, enzymes, enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, and/or pigments. In addition to the disclosure below, suitable examples of such other adjuncts and levels of use are found in U.S. Pat. Nos. 5,576,282, 6,306,812 B1 and 6,326,348 B1.

The cleaning composition of the invention may comprise from 0.05% to 30% by weight of one or more surfactant(s). Preferably, the cleaning composition comprises from 0.1% to 25% of surfactant, typically from 0.5% to 20%, or from 1% to 15%, or from 2% to 10% by weight of surfactant. The surfactant may be anionic, nonionic and/or cationic.

The cleaning composition of the invention may comprise from 0.05% to 30% by weight of one or more anionic surfactant. The cleaning composition may comprise 0.1% to 20%, in particular from 0.5% to 15% or from 1% to 13%, or even from 1.5% to 11% or from 2% to 8% by weight of anionic surfactant.

In particular, the anionic surfactant may comprise anionic surfactants selected from alkyl ester sulfonate(s); linear, branched, and modified alkylbenzene sulfonate(s); C₁₀-C₁₈ alkyl alkoxy sulfates; C₁₀-C₂₀ primary, branched-chain and random alkyl sulfates; C₁₀-C₁₈ secondary (2,3) alkyl sulfates; C₁₀-C₁₈ alkyl alkoxy carboxylate(s); fatty acid(s); mid-chain branched alkyl sulfate(s); mid-chain branched alkyl alkoxy sulfate(s); alpha-olefin sulfonate(s); phosphate ester(s); and mixtures thereof.

The cleaning composition may comprise a non-ionic surfactant. Where present the non-ionic surfactant(s) is generally present in amounts of from 0.01wt % to 20wt %, or from 0.1wt % to 4wt % by weight of the cleaning composition.

The non-ionic surfactant can be selected from the group consisting of: alkyl polyglucoside and/or an alkyl alkoxylated alcohol; C₁₂-C₁₈ alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEx, wherein x=from 1 to 30, as described in more detail in U.S. Pat. No. 6,153,577, U.S. Pat. No. 6,020,303 and U.S. Pat. No. 6,093,856; alkylpolysaccharides as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

The cleaning composition may comprise a cationic surfactant. When present, preferably the cleaning composition comprises from 0.01wt % to 10 wt %, or from 0.1wt % to 2wt % cationic detersive surfactant.

Suitable cationic detersive surfactants are alkyl pyridinium compounds, alkyl quaternary ammonium compounds, alkyl quaternary phosphonium compounds, and alkyl ternary sulphonium compounds. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium surfactants as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and mixtures thereof.

Cationic surfactants may be chosen among mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride. Cationic surfactants such as Praepagen HY (tradename Clariant) may be useful and may also be useful as a suds booster.

The cleaning composition of the invention may comprise a builder. When a builder is used, the cleaning composition will typically comprise from 1% to about 40%, typically from 2 to 20%, or even from about 4% to about 15%, or from 5 to 10% by weight of builder(s).

The cleaning composition may comprise from 1% to about 40%, typically from 2 to 20%, or even from about 4% to about 15%, or from 5 to 10% by weight of builder(s), chelant(s), or, in general, any material which will remove calcium ions from solution by, for example, sequestration, complexation, precipitation or ion exchange.

The cleaning composition may comprise a chelant. Suitable chelants include diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). Preferably the ethylene diamine-N′N′-disuccinic acid is in S′S′ enantiomeric form. The composition of the invention may comprise less than 3% or less than 2% or 1%or 0.5% of each of the above mentioned chelants.

Builders include, but are not limited to, the alkali metal, ammonium and alkanolammonium salts of polyphosphates, alkali metal silicates, layered silicates, such as SKS-6 of Clariant®, alkaline earth and alkali metal carbonates, aluminosilicate builders, such as zeolite, and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, fatty acids, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

The cleaning composition may comprise less than 50%, in particular less than 25%, or less than 20%, 15%, 10%, or 5% by weight of phosphate and/or aluminosilicate builders.

The cleaning composition may comprise from 0 to 50%, in particular from 1% to 25%, or less than 20%, or less than 15%, or less than 10%, or less than 5%, or less than 1% by weight of phosphate builder(s).

The cleaning composition may comprise from 0 to 50%, in particular from 1% to 25%, or less than 20%, or less than 15%, or less than 10%, or less than 5%, or less than 1% by weight of aluminosilicate builder(s). The aluminosilicate builder may comprise zeolite.

The cleaning composition may comprise from 0 to 50%, in particular from 1% to 25%, or less than 20%, or less than 15%, or less than 10%, or less than 5%, or less than 1% by weight of of polycarboxylic acid(s) and salt(s) thereof.

The cleaning composition may comprise from 0 to 50%, in particular from 1% to 25%, or less than 20%, or less than 15%, or less than 10%, or less than 5%, or less than 1% by weight of layered silicate(s).

The cleaning compositions of the present invention may comprise from 0 to 50%, in particular from 1% to 25%, or less than 20%, or less than 15%, by weight of sodium carbonate.

The inventors have found that the composition of the invention could exhibit satisfying sudsing properties, even when a low level of builder and or of surfactant is used.

Preferably, the cleaning composition comprises a dispersant. The cleaning composition may comprise at least 0.2% or 0.4% or 0.6% or 0.8% or 1% by weight of dispersant, such as carboxymethyl cellulose.

Preferably, the cleaning composition of the invention contains less than 3%, preferably up to 1%, and most preferably less than 0.1% or less than 0.01% or 0.001% or even 0.0001% of suds suppressor selected from the group consisting of trimethyl-, diethyl-, dipropyl-, dibutyl-, methylethyl-, phenylmethyl polysiloxane, and mixtures thereof. Preferably, the composition of the invention contain less than 3%, preferably up to 1%, and most preferably less than 0.1% or less than 0.01% or 0.001% or even 0.0001% of suds suppressor.

### Cleaning Composition

The composition may be in any liquid or solid form, in the form of gel, paste, dispersion, preferably a colloidal dispersion or any combination thereof. The cleaning composition is preferably in a solid form or in the form of a paste. The cleaning composition may be in particulate form, for example in free-flowing particulate form. The composition in solid form can be in the form of an agglomerate, granule, flake, extrudate, bar, tablet or any combination thereof.

The cleaning composition may be capable of cleaning and/or softening fabric during a laundering process. The cleaning composition may be a hair care, or a dish care composition.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

The following examples are given by way of illustration only and therefore should not be construed to limit the scope of the invention.

### EXAMPLES

### Example 1

### Preparation of Hemicellulose-Cellulose from Sycamore Leaves and Pine Sawdust

Sycamore leaves are collected and dried in an oven at 60° C. until there is no further weight loss. The dried leaves are then coarsely ground in a Braun food mixer and are then ground further in a Retzsch mill. The ground material is then sieved through a 150 μm sieve and the fine material that passes through the sieve is collected.

Pine sawdust is likewise dried at 60° C. until there is no further weight loss. The dry sawdust is then ground in a Retsch mill and the ground material sieved through a 150 μm sieve.

40 grams of the fine, ground Sycamore leaves are mixed into 250 g of deionised water. 40 g of the fine, ground sawdust is then added to the mixture. 25 g of sodium carbonate are then added to the mixture by stirring and the mixture is heated with vigorous stirring by hand to 70° C. This solubilises the hemicellulose and causes a thickening of the mixture to a thick paste-like consistency. After 20 minutes of agitation, the resulting paste is spread out to a thickness of less than 5 mm on a tray and placed in an oven at 60° C. until there is no further weight loss. The dried material is then removed and ground.

### Example 2

### Preparation of Hemicellulose-Cellulose from Dandelion Leaves Burdock Leaves and Flowers and Pine Saw Dust

Dandelion leaves are collected and dried in an oven at 60° C. until there is no further weight loss. The dried leaves are then coarsely ground in a Braun food mixer and are then ground further in a Retzsch mill. The ground material is then sieved through a 150 μm sieve and the fine material that passes through the sieve is collected.

Burdock leaves and flowers are collected and dried in an oven at 60° C. until there is no further weight loss. The dried leaves and flowers are then coarsely ground in a Braun food mixer and are then ground further in a Retzsch mill. The ground material is then sieved through a 150 μm sieve and the fine material that passes through the sieve is collected.

Pine sawdust is likewise dried at 60° C. until there is no further weight loss. The dry sawdust is then ground in a Retsch mill and the ground material sieved through a 150 μm sieve.

30 grams of the fine, ground dandelion leaves are mixed into 250 g of deionised water along with 10 g of the dried, ground burdock leaves and flowers. 40 g of the fine, ground pine sawdust is then added to the mixture. 25 g of sodium carbonate are then added to the mixture by stirring and the mixture is heated with vigorous stirring by hand to 70° C. This solubilises the hemicellulose and causes a thickening of the mixture to a thick paste-like consistency. After 20 minutes of agitation, the resulting paste is spread out to a thickness of less than 5 mm on a tray and placed in an oven at 60 C until there is no further weight loss. The dried material is then removed and ground.

### Example 3

### Fabric Care Compositions

| | Composition | Composition | Composition | Composition |
|---|---|---|---|---|
| | A | B | C | D |
| Component | Concentration (Weight percents) | | | |
| Sodium LAS | 12 | 14 | 8 | 5 |
| Sodium AE3S | 2 | | | |
| Sodium AE1S | | 2 | | 3 |
| Material of | 50 | | 10 | |
| Example 1 | | | | |
| Material of | | 25 | 30 | 50 |
| Example 2 | | | | |
| Cationic | 0.7 | 0.8 | 0.6 | 0.5 |
| surfactant | | | | |
| Non ionic | 0.3 | 0.3 | | |
| surfactant | | | | |
| Sodium | 16 | 35 | 26 | 16 |
| carbonate | | | | |
| Silicate | 3 | 4 | 7 | 8 |
| Other polymers | 5 | 6 | 3 | 5 |
| enzyme | 2 | 1.5 | 2.5 | 2.6 |
| Bleach system | 6 | 5 | 8 | 6 |
| Sodium sulfate, | bal | bal | bal | bal |
| Water and | | | | |
| miscelaneous | | | | |

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Cleaning composition comprising polysaccharides, the polysaccharides comprising from about 5 to about 95% by weight of water-soluble, unsubstituted hemicellulose.

2. A cleaning composition according to claim 1, comprising from about 1% to about 15% by weight of surfactant.

3. A cleaning composition according to claim 1, the polysaccharides comprising from about 20 to about 80% by weight of water-soluble, unsubstituted hemicellulose

4. A cleaning composition according to claim 1, comprising at least about 10% by weight of water soluble, unsubstituted hemicellulose.

5. A cleaning composition according to claim 1, wherein the cleaning composition comprises cellulose and wherein the weight ratio of cellulose to water-soluble, unsubstituted hemicellulose is between about 0.02 and about 20.

6. A cleaning composition according to claim 1, wherein the water-soluble, unsubstituted hemicellulose has been obtained by milling a plant material to a size of less than about 100 μm.

7. A cleaning composition according to claim 1, wherein the water-soluble, unsubstituted hemicellulose has been bleached.

8. A cleaning composition according to claim 1, wherein the water-soluble, unsubstituted hemicellulose has been obtained by mixing a plant material with an alkaline solution of pH above about 8.
